(19) United States
(12) Patent Application Publication
(10) Pub. No.: US 2012/0066029 A1
(43) Pub. Date: Mar. 15, 2012

(54) COMPUTER SYSTEM AND METHOD FOR DETERMINING A GEOGRAPHIC REGION FROM WHICH TO SOURCE A RESOURCE

(76) Inventors: Pierre Francois Kaltenbach, Paris (FR); Wenjing Yuan, Paris (FR)

(21) Appl. No.: 12/301,266

(22) PCT Filed: May 19, 2006
(86) PCT No.: PCT/IB06/01994

§ 371 Date: Apr. 1, 2010

(51) Int. Cl. G06Q 10/06

(52) U.S. Cl. 705/7.34

(57) ABSTRACT

A computer system for determining a geographic region from which to source a resource. The computer system has an associated database which stores region-specific cost data for each of a plurality of geographic regions (e.g. countries). The computer system is operable to present an interface to enable a user to input resource data for a resource; to store the resource data; to calculate a potential cost of sourcing the resource from each of the plurality of geographic regions based on the region-specific cost data and the resource data; and to output the calculated potential cost of sourcing the resource from one or more of the plurality of geographic regions. Advantageously, the should be cost of sourcing a resource from a low cost region can be calculated and used to identify the best low cost region sourcing opportunities.

The present invention relates to a computer system and method for determining a geographic region from which to source a resource. In particular, but not exclusively, the present invention relates to a computer system and method for determining a low cost geographic region from which to source one or more manufactured resources such as manufactured parts for industrial equipment and the automotive industry.

### BACKGROUND

Some geographic regions, for example the United States of America and the United Kingdom, are considered to be high cost geographic regions for certain resources such as certain manufactured parts. Other geographic regions, for example China and India, are considered to be low cost geographic regions for some resources. Depending on the characteristics of a particular study, a geographic region can be a group of countries, a country or a part of a country. When a study is focussed at the country level, reference may be made to high cost countries (HCCs) and low cost countries (LCCs).

It can be desirable for an organization, such as a manufacturer for example a manufacturer of construction equipment, mining equipment or engines, to source resources such as manufactured parts for a high cost geographic region from a low cost geographic region. Some organizations recognize this and source certain resources from low cost geographic regions. There are several potential barriers to sourcing a resource from a low cost geographic region, including that low cost region sourcing may be a low priority and a typical organization is not set up to use efficiently low cost region sourcing, that people within an organization may not know who to contact, that there may be a lack of knowledge of which regions would be low cost for a particular procurement and that there may be communication barriers, not least language barriers, between a buyer in a high cost region and a supplier in a low cost region. If low cost region sourcing is used, or at least considered, then a typical approach is to ask one or more potential suppliers in one or more low cost regions to provide a quotation, sometimes referred to as a “Request for Quotation”, and to base the procurement decision on the resulting quotations.

### SUMMARY OF THE INVENTION

In one embodiment of the invention, a computer system is provided for determining a geographic region from which to source a resource. The computer system has an associated database which stores region-specific cost data for each of a plurality of geographic regions. The computer system is operable to present an interface to enable a user to input resource data for a resource; to store the resource data; to calculate a potential cost of sourcing the resource from each of the plurality of geographic regions based on the region-specific cost data and the resource data; and to output the calculated potential cost of sourcing the resource from one or more of the plurality of geographic regions.

In another embodiment of the invention, a method for determining a geographic region from which to source a resource is provided on a computer system. The computer system has an associated database which stores region-specific cost data for each of a plurality of geographic regions. The method comprises presenting an interface to enable a user to input resource data for a resource; storing the resource data; calculating a potential cost of sourcing the resource from each of the plurality of geographic regions based on the region-specific cost data and the resource data; and outputting the calculated potential cost of sourcing the resource from one or more of the plurality of geographic regions.

In another embodiment of the invention, a method for determining a geographic region from which to source a resource is provided. The method comprises determining region-specific cost data for each of a plurality of geographic regions; determining resource data for a resource; calculating a potential cost of sourcing the resource from each of the plurality of geographic regions based on the region-specific cost data and the resource data; and using the calculated potential costs to determine from which geographic region to source the resource.

Some embodiments of the invention may include or utilize computer-executable instructions for performing one or more of the disclosed methods. The computer-executable instructions may be stored on a computer-readable medium, such as a portable memory drive, CD-ROM, RAM, ROM, or any other suitable memory structure whether local to a processor(s) via a bus or remotely located such as remote memory accessible via the Internet or other network.

The region-specific cost data may comprise one or more of labor cost data, energy cost data, raw material cost data, supplier margin data, transportation cost data, inventory period data and currency exchange data. The resource data may comprise resource logistic data comprising one or more of source geographic region data, receiving facility data, transportation limit data, resource transportation data, vendor payment time data, on hand time data and weighted average cost of capital data. The potential cost may be calculated as one or more of an ex-works cost and a total landed cost.

Advantageously, a computer system and method is provided which can be used to determine a geographic region from which to source a resource. The computer system and method can be used by an organization for efficient low cost region sourcing, by efficiently identifying the best low cost region sourcing opportunities. Cost drivers may vary from region to region and from resource to resource, and the system and method may be used to identify the target low cost region for a range of resources. By calculating a potential cost of sourcing the resource from each of the plurality of geographic regions based on the region-specific cost data and the resource-specific cost data, the calculated potential cost is an indication of what the sourcing cost from each regions should be. Therefore, a buyer can approach potential suppliers in a region knowing this should be cost, rather than relying on the results of Requests for Quotations, and the buyer can use the should be cost to effectively negotiate with the suppliers.

Other features and advantages of embodiments of the invention will be apparent from the following description.

### BRIEF DESCRIPTION OF THE DRAWINGS

Particular embodiments of the invention will now be described, by way of example only, with reference to the accompanying drawings, in which:

FIG. 1 illustrates a computer system of an embodiment of the present invention.

FIG. 2 illustrates an example of the external view of the computer system.

FIG. 3 is a schematic representation of the architecture of the computer system.

FIG. 4 illustrates an alternative configuration for the computer system.

FIG. 5 is a flow diagram showing the functional steps performed by the computer system in an embodiment of the present invention.

FIG. 6 shows a time line from shipment, through receipt to sale for an example component.

FIG. 7 illustrates an interface to enable a user to input data in an embodiment of the present invention.

FIGS. 8 to 10 illustrate an interface to enable a user to input resource specific data in an embodiment of the present invention.

FIGS. 11 to 17 illustrate an interface to enable a user to input resource logistic data in an embodiment of the present invention.

FIG. 18 illustrates an interface to enable a user to input as-is cost data in an embodiment of the present invention.

FIG. 19 illustrates an interface to enable a user to input supplier margin data in an embodiment of the present invention.

FIG. 20 shows the interface of FIG. 7.

FIG. 21 illustrates a message and interface presented to a user before the calculation is performed in an embodiment of the present invention.

FIG. 22 illustrates an interface giving the user a set of output options and a set of example output interfaces.

FIGS. 23 to 25 show the example output interfaces of FIG. 21 in larger scale.

FIG. 26 shows the interface of FIG. 7 and illustrates interfaces to check for outdated region-specific cost data.

FIGS. 27 to 34 illustrate different interfaces to update region-specific cost data.

### DETAILED DESCRIPTION

Embodiments of the present invention relate to computer systems and methods for determining a geographic region from which to source a resource.

A computer system may include any suitable structure that processes digital information including but not limited to one or more devices that employ one or more processors or discrete logic (e.g., application specific integrated circuits or state machines) or other suitable structure whether implemented as hardware, software, firmware or any suitable combination, that carries out the operations described herein. A computer system may include a cell phone, other handheld device or any suitable device or devices.

In overview, a method for determining a geographic region from which to source a resource may be provided. The method may comprise determining region-specific cost data for each of a plurality of geographic regions; determining resource data for a resource; calculating a potential cost of sourcing the resource from each of the plurality of geographic regions based on the region-specific cost data and the resource data; and using the calculated potential costs to determine from which geographic region to source the resource. The method may also comprise sourcing the resource from one or the geographic regions.

The region-specific cost data may be stored in a database and the resource data for a resource, e.g. a manufactured part or component such as a forged part (e.g. a piston rod) or a cast component (e.g. a valve), can be entered using an interface on a computer system associated with, i.e. having access to, the database. The computer system may perform the calculation.

The method can be used by an organization for efficient low cost region sourcing, by efficiently identifying the best low cost region sourcing opportunities. By calculating a potential cost of sourcing the resource from each of the plurality of geographic regions based on the region-specific cost data and the resource-specific cost data, the calculated potential cost is an indication of what the sourcing cost from each regions should be. Since embodiments of the invention can determine a low cost geographic region, e.g. a low cost country, from which to source one or more manufactured resources by calculating a potential cost, or should be cost, of sourcing the resource from the region, the tool provided by embodiments of the invention can be referred to as the Low Cost County Should Cost Model or, in abbreviated form, the LCC Should Cost Model.

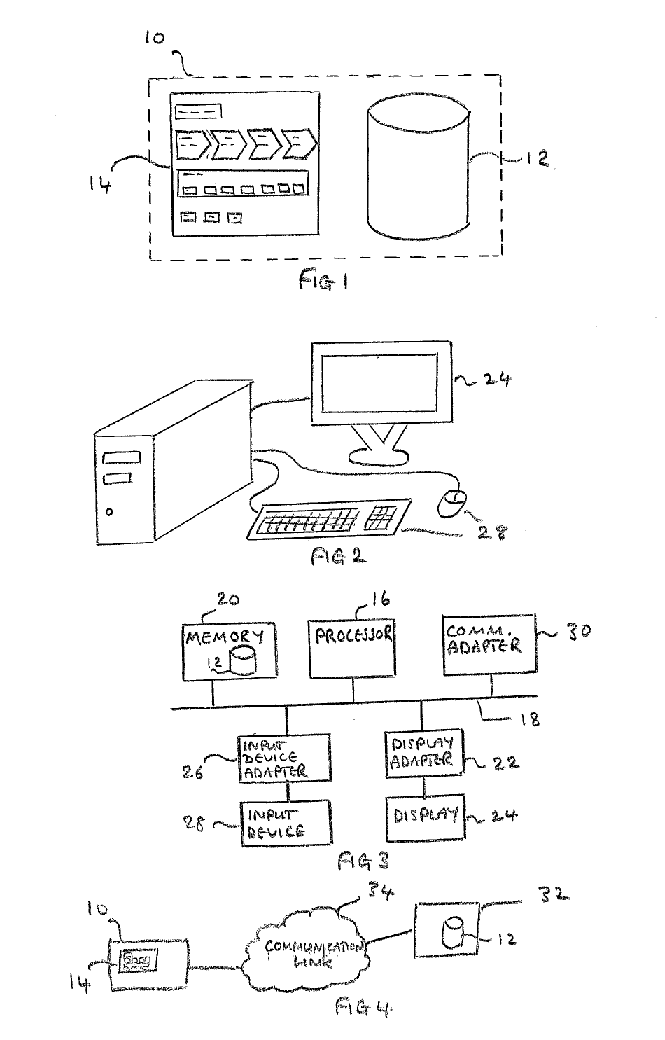

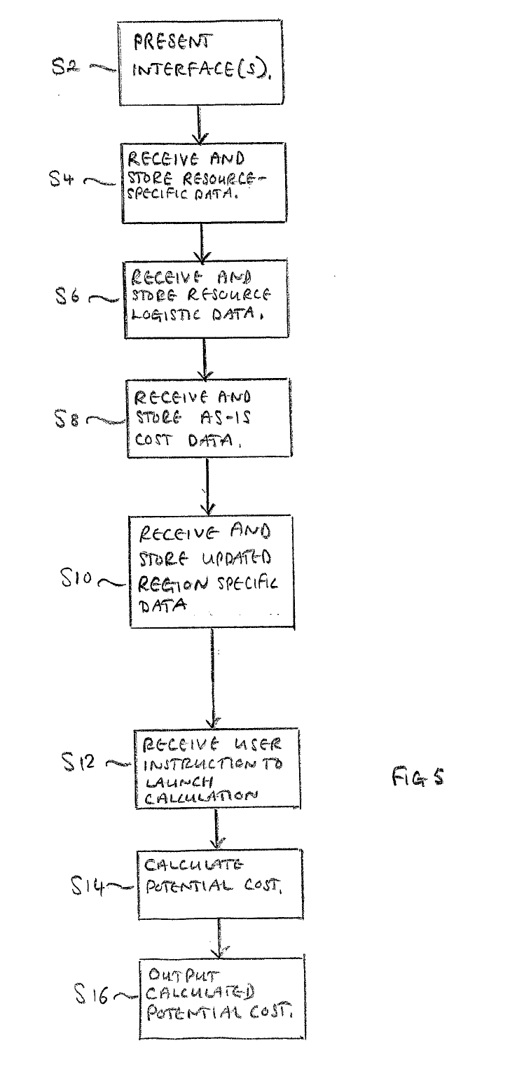

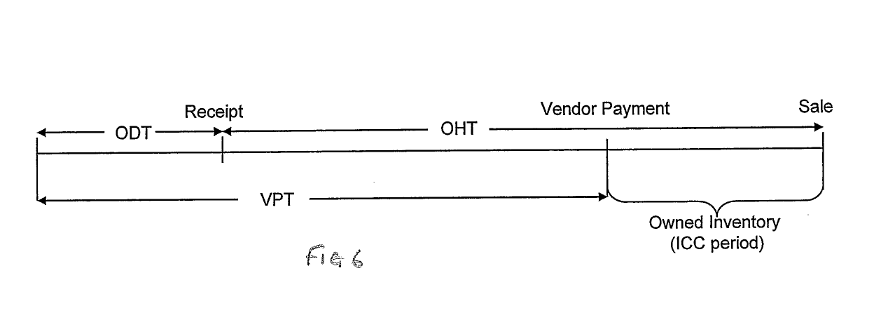

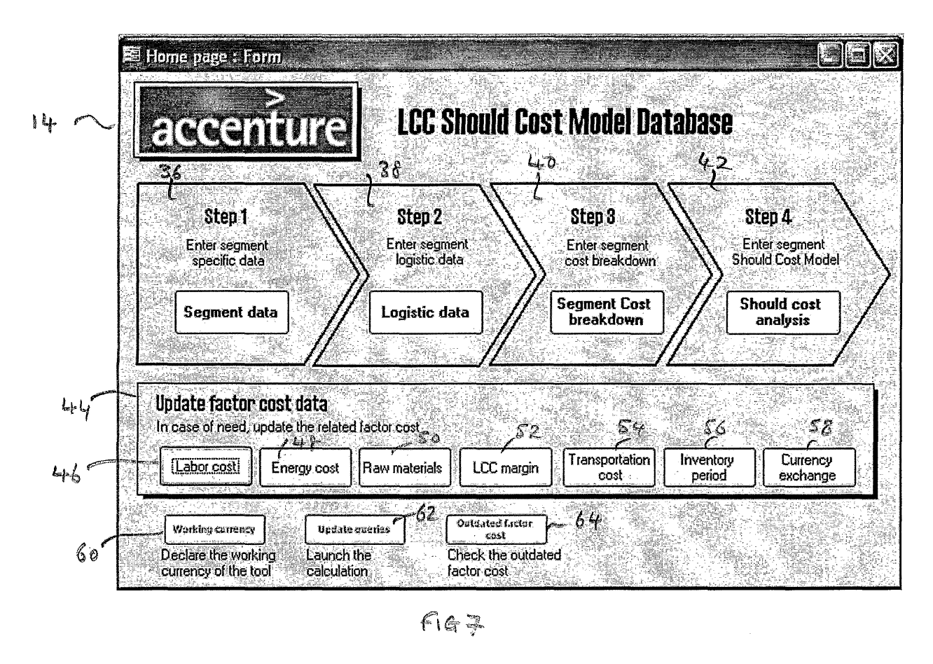

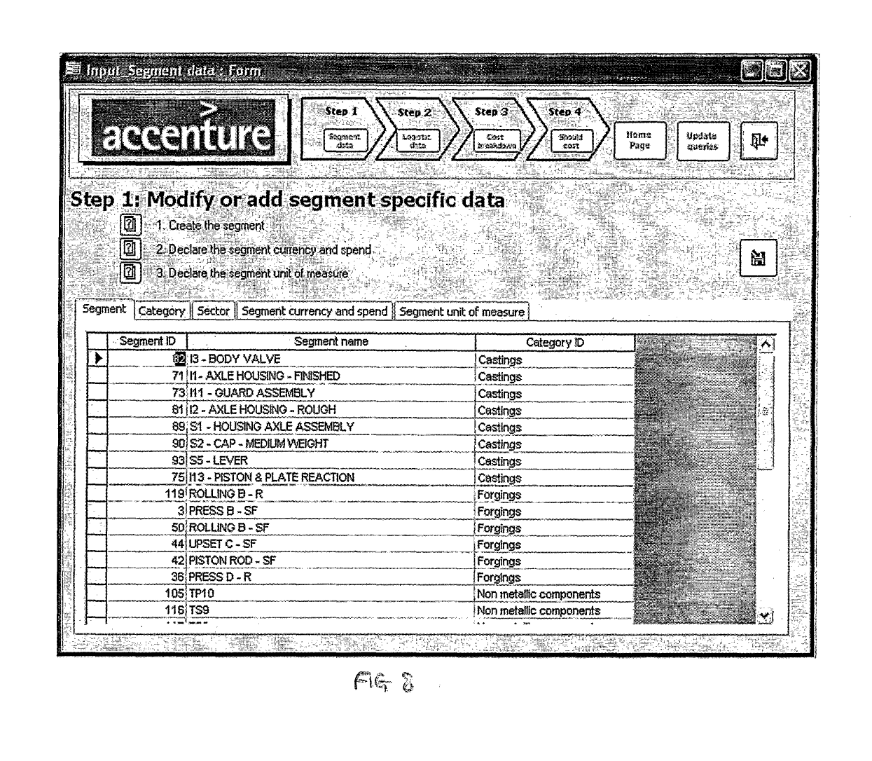

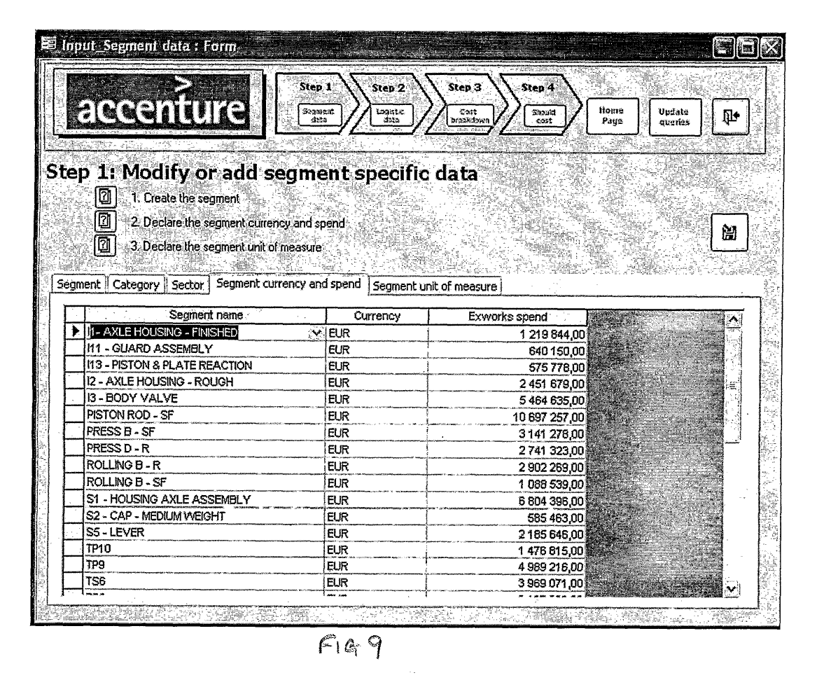

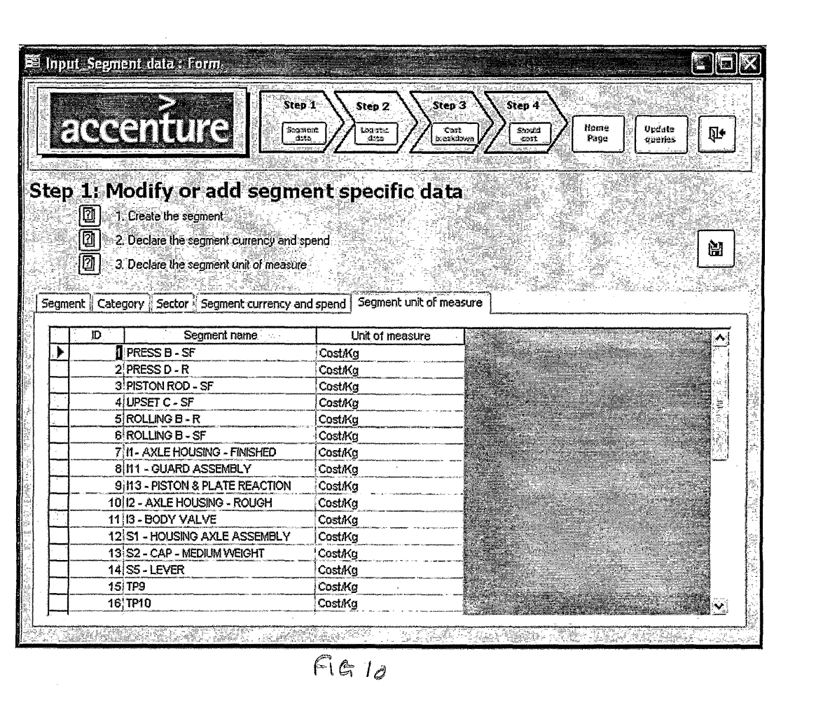

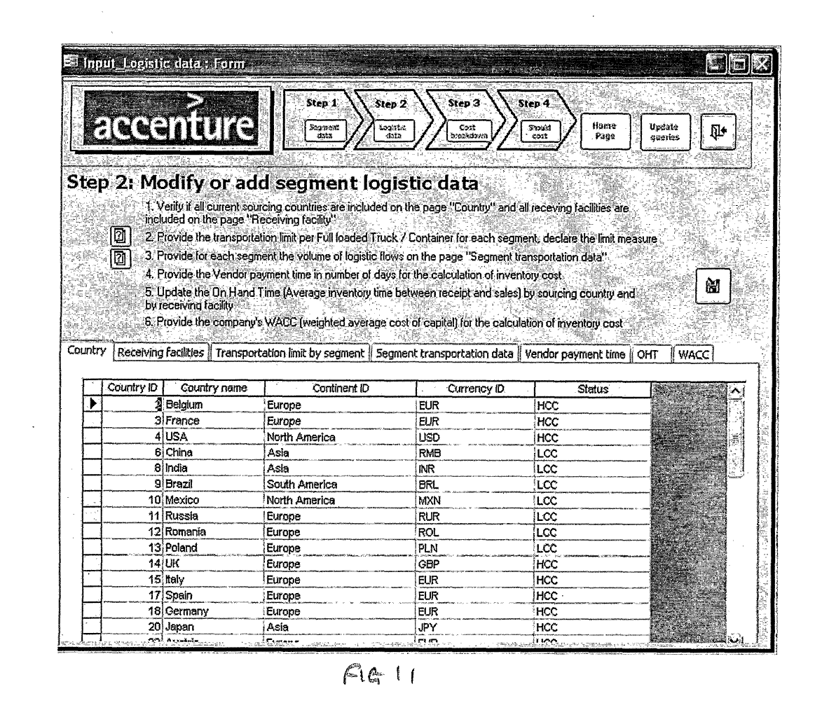

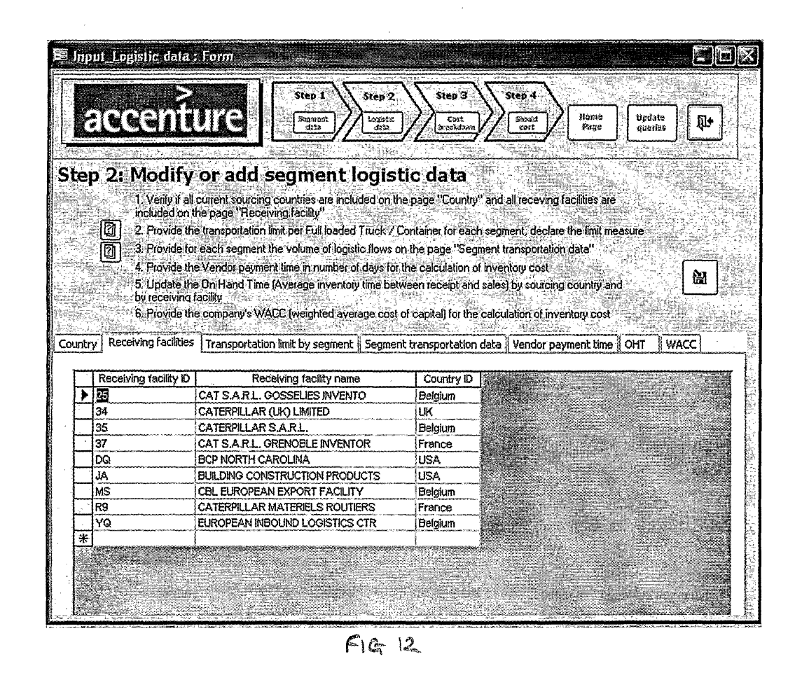

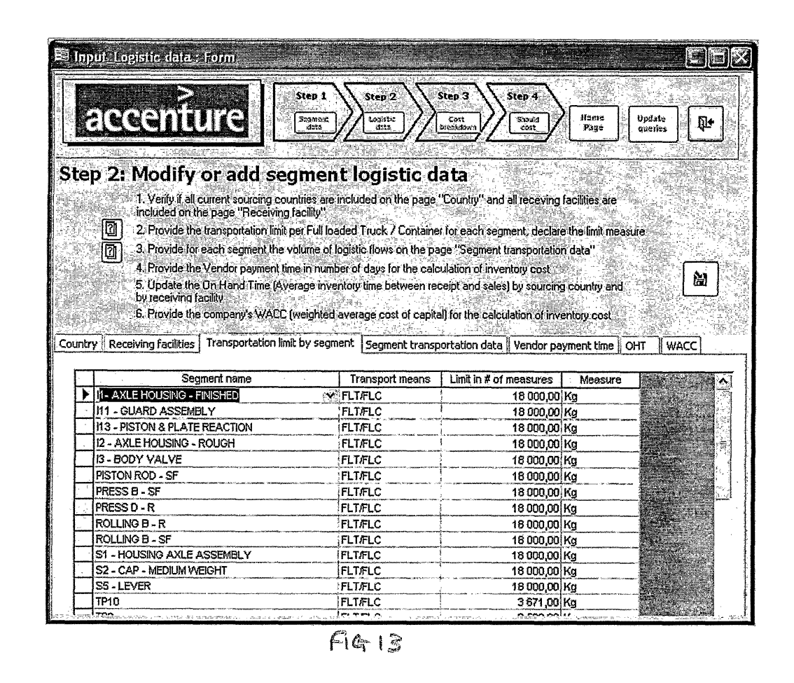

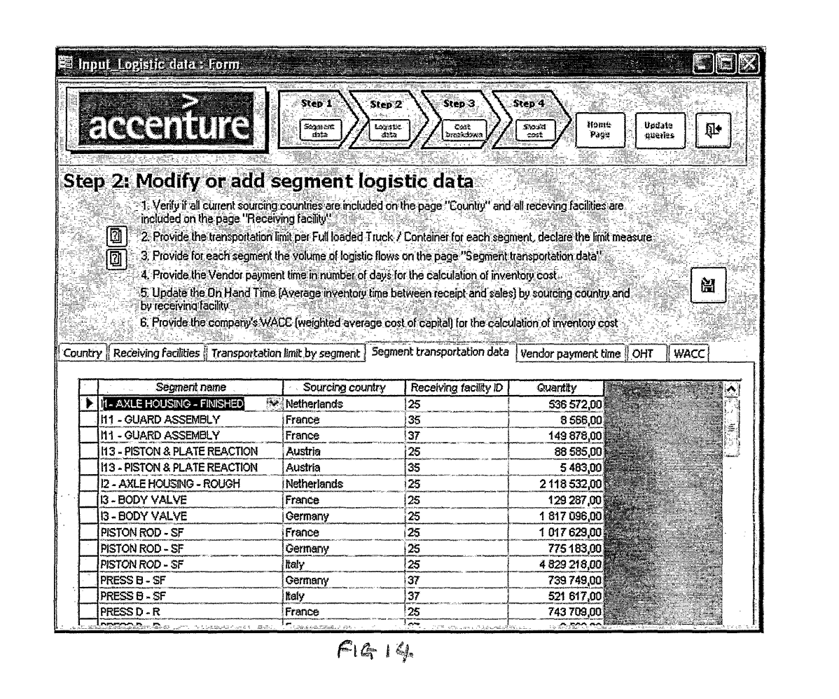

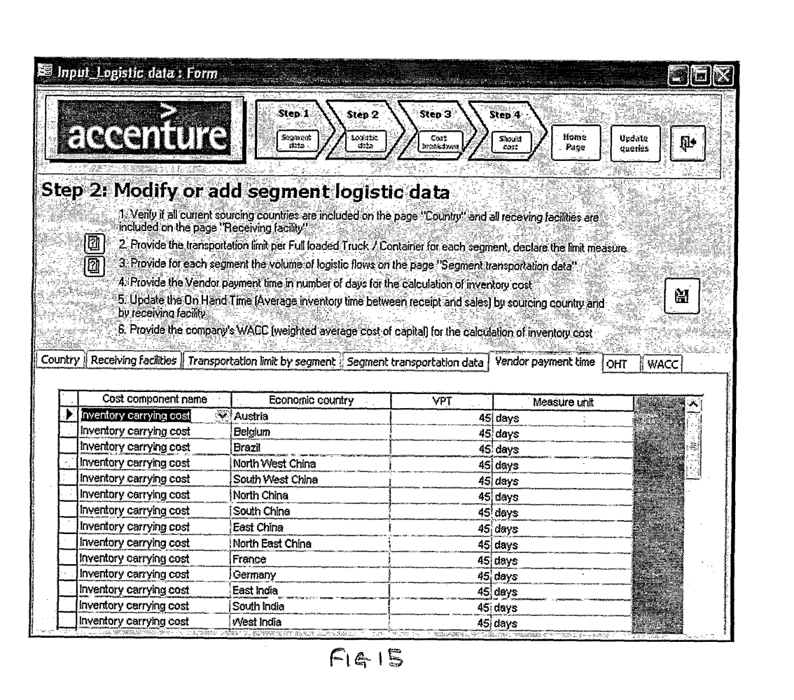

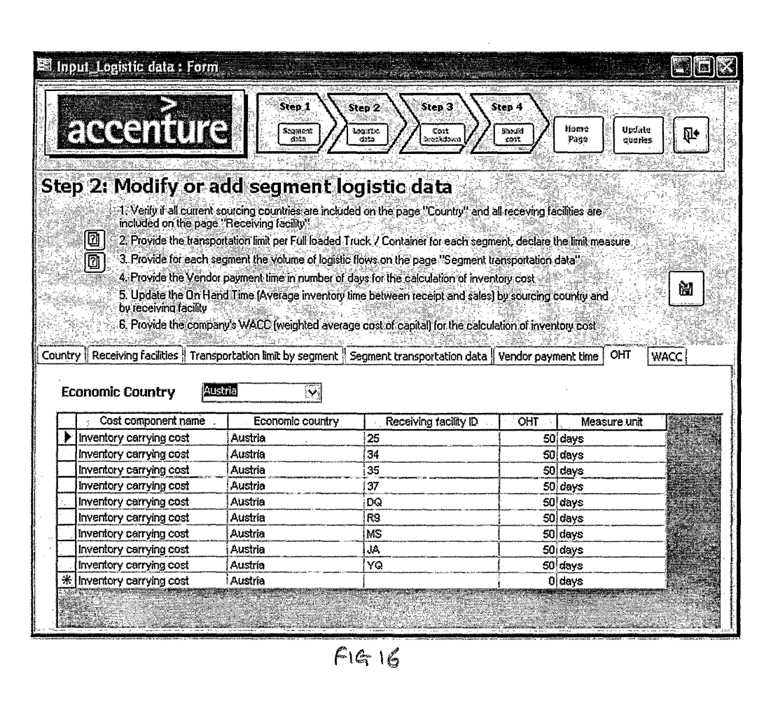

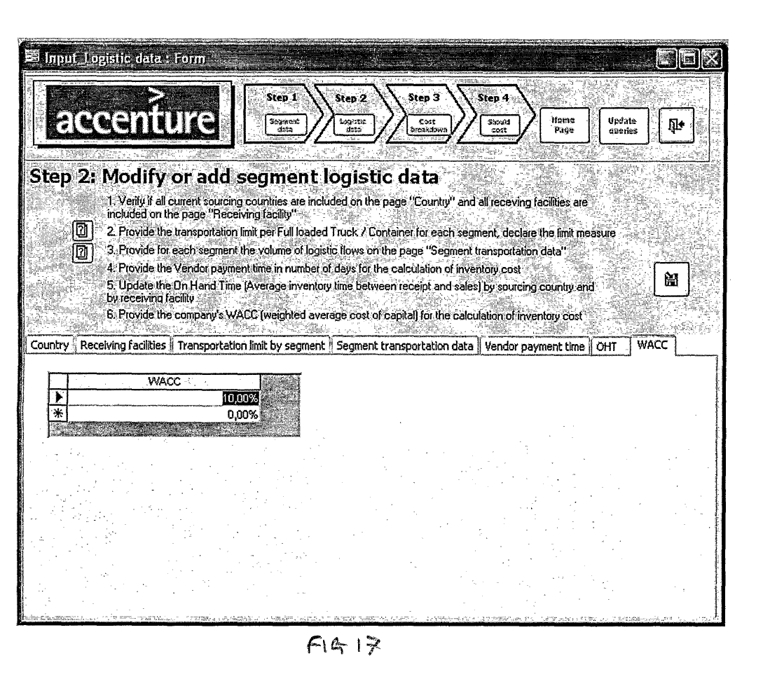

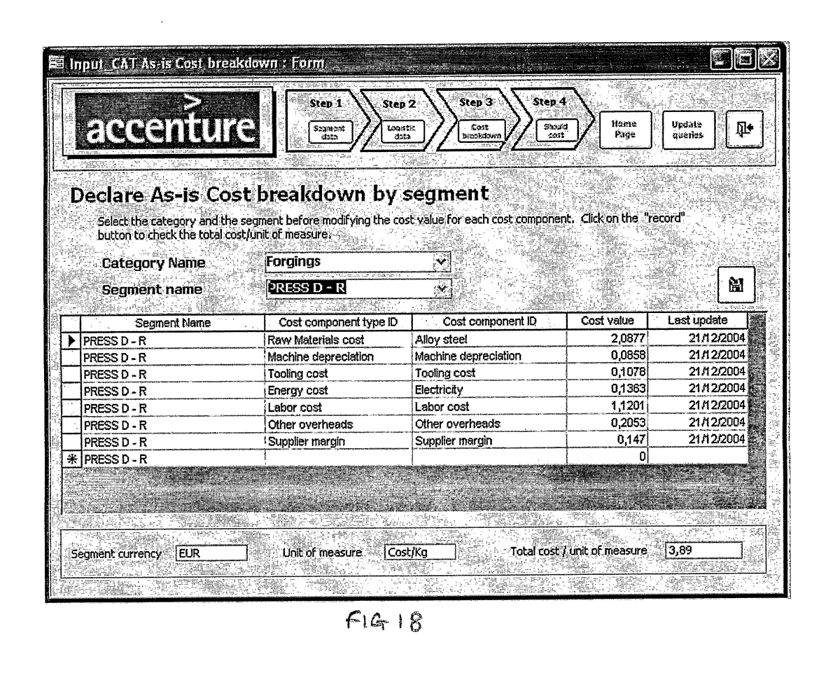

FIG. 1 illustrates a computer system of an embodiment of the present invention. Computer system 10 is for determining a geographic region from which to source a resource. The computer system 10 has an associated database 12 which stores region-specific cost data for each of a plurality of geographic regions. The computer system is operable to present an interface 14 to enable a user to input resource data for a resource. The computer system 10 is operable store the resource data, optionally in database 12 or separately.

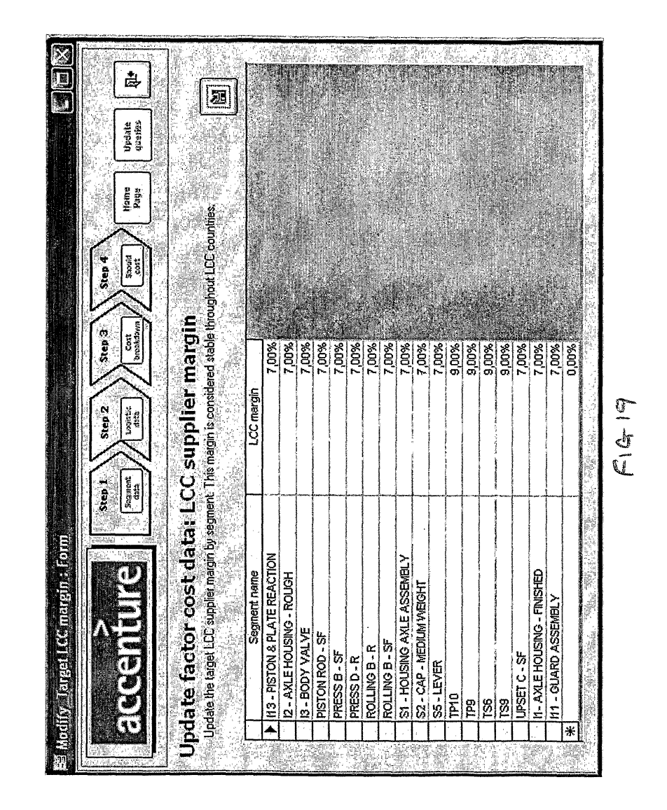

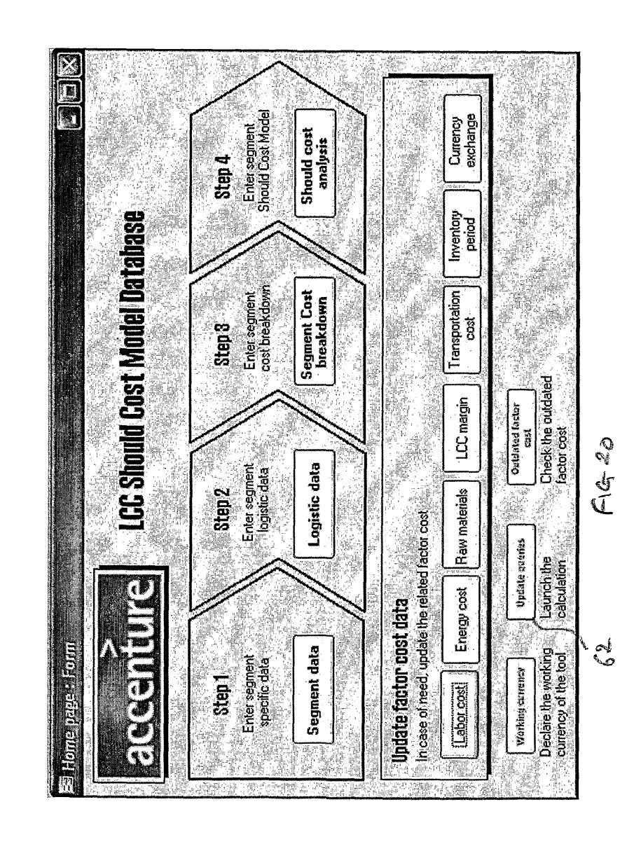

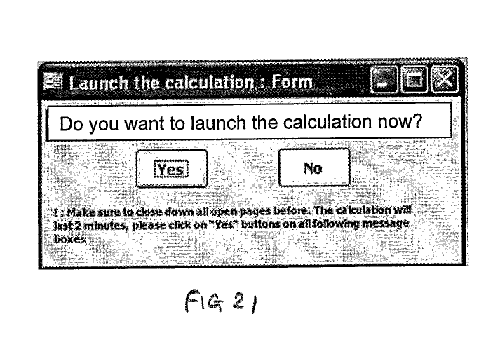

FIG. 2 illustrates an example of the external view of the computer system, and FIG. 3 is a schematic and simplified representation of the computer architecture.

The computer 10 comprises various data processing resources such as a processor 16 coupled to a bus structure 18. Also connected to the bus structure 18 are further data processing resources such as memory 20. A display adapter 22 connects a display 24 to the bus structure 18. A user input device adapter 26 connects a user-input device 28 to the bus structure 54. A communications adapter 30 may also be provided to communicate with other computers across a communication link such as a computer network.

In operation the processor 16 can execute instructions that may be stored in memory 20. The results of the processing performed may be output or displayed to a user via the display adapter 22 and display device 24. User inputs may be received through input device adapter 26 by a user using input device 28. The inputs can be displayed on interface 14.

Database 12 may be configured in memory 20 of computer system 10, as illustrated in FIG. 3. Optionally, the database may be configured on another computer system, such as computer system 32 illustrated in FIG. 4. Computer system 10 has access to database 12 across communication link 34, which may be a computer network, such as the internet, or a direct link.

It will be appreciated that the architecture of the computer system can vary considerably from those illustrated in FIGS. 2 to 4.

FIG. 5 is a flow diagram showing the functional steps performed by the computer system in an embodiment of the present invention. The computer system 10 can be operable to perform these functional steps, for example the processor 16 of computer system 10 may be programmed with computer executable instructions to perform the steps.

Before referring to FIG. 5, the functional steps performed by computer system 10 in overview are: (i) present an interface to enable a user to input resource data for a resource; (ii) store the resource data; (iii) calculate a potential cost of sourcing the resource from each of the plurality of geographic regions based on the region-specific cost data and the resource data; and (iv) output the calculated potential cost of sourcing the resource from one or more of the plurality of geographic regions.

The resource data may comprise resource-specific data and resource logistic data, which may be input through separate interfaces. Other data may also be input or modified through other interfaces.

Referring to FIG. 5, at step S2 the computer system present an interface (such as the interface of FIG. 7). It will be appreciated that the various data input and displayed in embodiments of the present invention may be through any suitable arrangement of interfaces. The particular individual interfaces of particular embodiments will be described later with reference to FIG. 7 onwards and it will be appreciated that the display of particular individual interfaces is not shown in FIG. 5, but rather is depicted by step S2 as “present interface(s)”.

At step S4, the computer system receives and stores the resource-specific data.

At step S6, the computer system receives and stores the resource logistic data.

At step S8, the computer system receives and stores the “as-is” cost data, that may be supplied by the user. The as-is data represents the current cost data for sourcing the resource and may be used for cost comparisons to show the potential saving of sourcing from a low cost region.

The computer system may receive and store supplier margin data, that may be supplied by the user at this stage.

At step S10, the computer system receives and stores updated region-specific cost data, that may be supplied by the user.

All of the data received in steps S4 to S10 may be stored in database 12, or separately. In a particular embodiment, all data is stored in database 12.

At step S12, the computer system 10 receives a user instruction to launch the calculation. At step S14 the computer system 10 calculates a potential cost of sourcing the resource from each of the plurality of geographic regions based on the region-specific cost data and the resource data.

At step S16, the computer system 10 outputs the calculated potential cost of sourcing the resource from one or more of the plurality of geographic regions.

Embodiments of the invention may be implemented using database tools such as Microsoft Access. Such a database tool can provide the database, interfaces and computer executable instructions used.

Some embodiments of the invention may be used to calculate the potential cost for a single resource. In other embodiments the potential costs may be calculated for multiple resources. In these embodiments “resource segments” may be used, each resource segment corresponding to a respective resource. The computer system may be operable to output the calculated potential cost by resource segment in such embodiments.

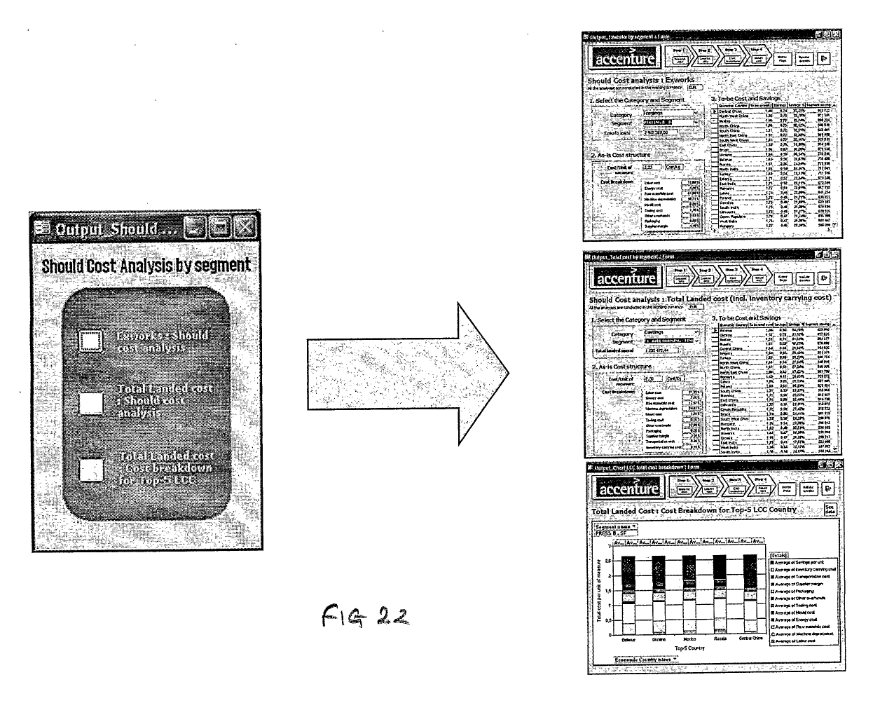

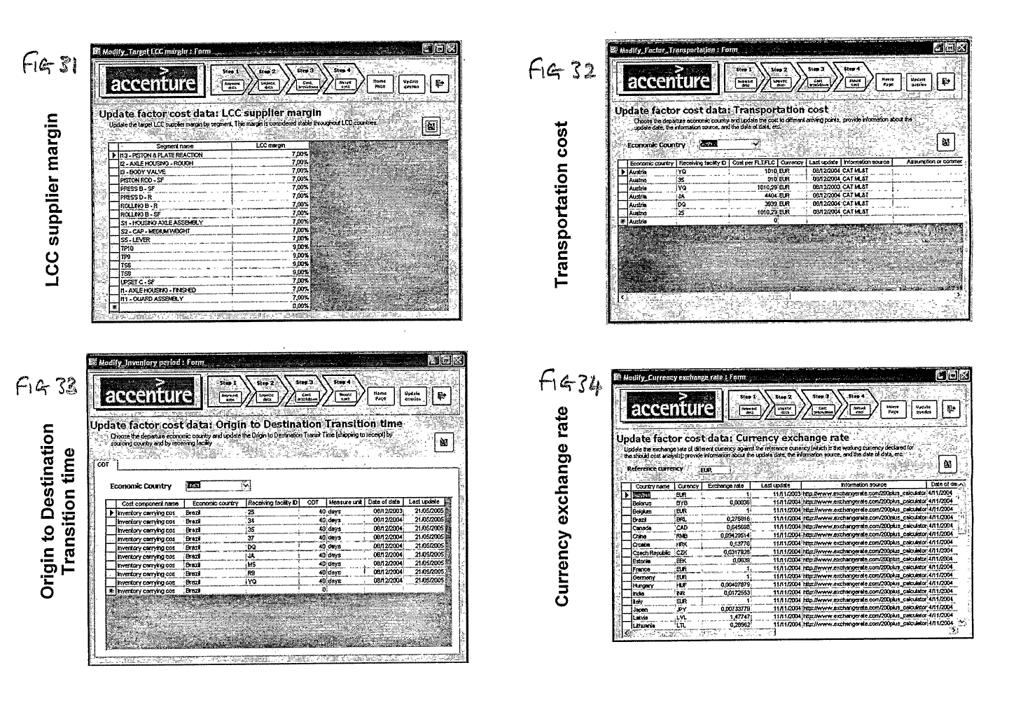

An embodiment using multiple resources and “resource segments” will be described with reference to FIGS. 7 to 34, although it will be appreciated that the described features may be implemented in other embodiments including a single resource embodiment.

In the embodiment described with reference to FIGS. 7 to 34, the potential cost (i.e. the purchasing cost) of a manufactured resource is defined based on a cost structure which is the combination of different cost drivers. The cost drivers include: labor cost, raw material cost, machine depreciation, tooling/mould cost, energy cost, overheads cost, packaging costs, supplier margin, and transportation costs. In other words, the potential cost for a geographic region (e.g. country) is a combination of several cost components corresponding to these costs. The cost structure changes by sourcing geographic region since the values of certain costs drivers differ between them. The costs that change by sourcing region in this embodiment are labor cost and productivity, raw materials cost, energy cost, supplier margin, and transportation cost. These are referred to as “factor costs”. Cost drivers other than factor costs are not considered to change by geographic region. For example, machine depreciation, tooling and mould cost and packaging cost are considered as unchanged from high cost region to low cost region. Also, for overheads the overheads ratio (overheads/ex-works cost) are considered as remaining stable from high cost region to low cost region. The potential cost for each region is derived from the applied cost structure, based on relative comparison of quantifiable factor costs between regions. Potential low cost regions are defined at country level for all except China and India, which may be defined as a combined geographic region.

A factor cost may be broken down into multiple cost components to provide a further level of resolution. For example, raw materials may be broken down to “Carbon steel”, “Ductile iron” or “Plastic—ABS” which represent different types of raw materials used for manufacturing different segments of resources.

The approach, calculation rule and data source for each of the “factor costs” (the region-specific cost data) of the described embodiment is as follows. For some segments, certain factor costs may be resolved or consolidated into categories which have similarities in terms of procurement characteristics, for example a castings and forgings category or a non-metallic category can be used for margin data.

Labor cost and productivity: For all categories, the hourly labor cost is used. For each category, a productivity index may be used to adjust the hourly labor cost. Labor cost is calculated using the relative ratio of hourly labor cost between low cost geographic region and the initial high cost sourcing geographic region. The data source for labor cost is the International Labor Organization, Eurostat, US Bureau of Labor Statistics (see annex, item (1) for details).

Raw Materials: According to the type of raw materials used, the cost can be either global or region-specific. The cost set in the model is independent of each supplier's bargaining power. The data source is the organization's purchasing team(s).

Energy: For all categories, the energy cost depends on the electricity which represents most of each suppliers major energy consumption. The energy cost is calculated using the relative ratio of electricity cost/kwh between the low cost region and the initial high cost sourcing region. The data source is the International Energy Agency; Eurostat (see annex, item (2) for details).

Overheads: For all categories, suppliers working in the same sector are assumed to have the same overheads burden rate throughout the world. The percentage of overheads compared to the ex-works cost remains unchanged from high cost region to low cost region. No data source is required.

Margin: For all categories, the low cost region suppliers have a higher margin ratio that high cost region suppliers. For castings and forgings category suppliers, a 7% margin ratio is used. For non-metallic category suppliers, a 9% of margin ratio is used. The data source is an average of the organizations RFI results.

Transportation: For all categories, transportation is assumed to be conducted in full loaded container (FLC) (20 ft) or full loaded truck (FLT) (18T) which have similar weight and dimension limits. The transportation cost is calculated using the relative ratio of cost/FLC and FLT for each logistic flow, between low cost regions and the initial high cost sourcing region. The data sources include ML&T Europe and validation of organization's local teams' data.

Inventory carrying costs: For all categories, the financial impact of owning inventory is driven by the purchaser's weighted average cost of capital (WACC), total supply chain transit times and vendor payment terms. Variable and fixed costs of holding inventory in warehouses is assumed not to be a driver in the sourcing decision. Inventory carrying cost is calculated using the purchaser's WACC and the amount of time inventory is owned before being sold. Data sources include industry averages and global transit times.

Currency exchange data: see annex, item (3) for details.

FIG. 6 shows a timeline from shipment, through receipt to sale for an example component for which an inventory carrying cost (ICC) can be calculated. The illustrated ICC variables and example values are:

WACC=Weighted Average Cost of Capital—10% per year.

ODT=Origin to Destination Transit time [shipping to receipt] (days)—20 days.

VPT=Vendor Payment Terms [starts on date of shipment] (days)—45 days.

OHT=On Hand Time is the average time inventory is on hand between Receipt and Sale [inverse of turns]—50 days.

COGS=Cost of Good Sold ($)—$1,000,000.

365=Number of days in year

The ICC calculation is as follows:

ICC=COGS*(WACC/365)*(OHT+ODT−VPT)

ICC=$1,000,000* 10%/365*(50+20−45)

ICC=$6,849

The data of WACC, ODT, VPT and OHT are set for a particular organization and can be customized for other organizations depending on the organization's practices and/or other factors.

FIG. 7 illustrates an interface to enable a user to input data in an embodiment of the present invention. The interface of FIG. 7 is a home or root interface.

In this embodiment the data entry steps to input (i) the resource specific data (c.f. step S4 of FIG. 5), (ii) the resource logistic data (c.f. step S6), (iii) the as-is cost data (c.f. step S8),) are shown as user selectable buttons 36, 38, 40. These buttons are labeled as Steps 1 to 3 respectively. In step 4 (c.f. step S16 of FIG. 5): once the data entry steps have been finished, and there is no need to update the different factor costs, the user can launch the calculation and enter step 4 to view the output data.

With reference to FIG. 7, the resource specific data is referred to as “Segment data”, the resource logistic data is referred to as “Logistic data”, the as-is cost data is referred to as “Segment Cost breakdown”.

The user can select each button 36, 38, 40 in turn to progress through the steps and enter the data which is stored by the computer system. It can be seen that the computer system is operable to enable the user to perform four general steps as follows.

In step 1, in response to a user selection of button 36 the computer system is operable to present the user with one or more interfaces to input the segment specific data by creating the segment, providing the segment spend, defining the segment currency and defining the unit of measure.

In step 2, in response to a user selection of button 38 the computer system is operable to present the user with one of more interfaces to input the segment logistic data which include current sourcing countries and receiving facilities, transportation limit by FLT/FLC by segment, and the quantity to transport within a segment.

In step 3, in response to a user selection of button 40 the computer system is operable to present one or more interfaces for the user to input the segment as-is cost breakdown.

In step 4, in response to a user selection of button 42 the computer system is operable to present one or more interfaces to enter the should cost analysis to calculate and output (a) ex-works analysis by segment, (b) total landed analysis by segment, and/or (c) a Top-5 low cost countries by segment based on total landed analysis

On the interface of FIG. 7, the user has the option of updating the region-specific data, referred to as the “factor cost data” stored in the database, by selecting any of buttons in the “Update factor cost data” area 44 in response to which the computer system is operable to present a particular interface respectively.

The region-specific cost data comprises labor cost data, energy cost data, raw material cost data, supplier margin data, transportation cost data, inventory period data and currency exchange data. The buttons in area 44 labor cost button 46, energy cost button 48, raw material cost button 50, supplier margin button 52, transportation cost button 54, inventory period button 56 and currency exchange button 56. Each of these buttons can be used to update the respective data.

The interface of FIG. 6 also comprises button 60 to declare the working currency for the tool based on which the should cost analysis is conducted, button 62 to launch the calculation (c.f. S12 of FIG. 5), which takes account of the most recent data entries which are stored by the computer system and button 64 to check for outdated region-specific cost data (factor costs).

FIGS. 8 to 10 illustrate the interfaces presented to the user by the computer system in response to the user selecting button 36 of interface 14 of FIG. 7. The resource specific data is input by the user using these interfaces and the computer system stores the input data in database 12 in tables corresponding to those shown in the Figures.

In FIG. 8, the user can first create one or more segments. The user can add a new segment or modify the name of existing segments on the illustrated “Segment” page. The user can define a relevant category for each segment. The user can select a predefined category or if required create a new category on the “Category” page. Optionally, the user can associate the category with a relevant sector of a set of predefined sectors or if required create a new sector on the “Sector” page.

Secondly, and now referring to FIG. 9 the user can define the segment currency and spend. A user has the option to define the segment currency on the “Segment currency” page. This currency is used as reference of the segment's annual spend as well as the segment cost breakdown. The segment currency can be the user's choice and different from the working currency which can be defined through button 60 of FIG. 7. The computer system can convert all data automatically to the working currency in the calculation stage.

Thirdly, and now referring to FIG. 10, the user can define the segment unit of measure. A user has the option to define the unit of measure for each specific segment. The defined unit of measure is the unit of measure used in the calculation. For example, the unit of measure can be: Cost/Kg, Cost/M3, Cost/Part, etc.

As will be appreciated form FIGS. 8 to 10, each segment can have a segment identifier (Segment ID) and a segment name.

FIGS. 11 to 17 illustrate the interfaces presented to the user by the computer system in response to the user selecting button 38 of interface 14 of FIG. 7. The resource logistic data is input by the user using these interfaces and the computer system stores the input data in database 12 in tables corresponding to those shown in the Figures.

In FIG. 11, the user can first verify that all current sourcing countries for the segments are in the list of countries and if not by creating new lines include them on the “country” page. As can be seen, each country has an country identifier (country ID), country name, continent identifier (continent ID), currency identifier (currency ID) and high cost country (HCC) or low cost country (LCC) status.

Similarly, with reference to FIG. 12, the user can verify that all receiving facilities for the segments are in the list on the “Receiving facilities” page and if not add the missing facilities. As is shown, each receiving facility has a receiving facility identifier (receiving facility ID), a receiving facility name and a county ID.

Secondly, with reference to FIG. 13, the user can provide transportation limit by FLT/FLC on the “transport limit by segment” page. As is shown, each segment has a segment name, a transport means, a limit in number of measures and a measure. To be able to calculate the transportation cost, users can estimate the transportation limit by full loaded truck (18T) or full loaded container (20 ft), specific to each segment. The limit is used to define the transportation limit per FLC/FLT and the measure conforms with the unit of measure defined in Step 1. For example, for the Segment A which has Cost/Kg as unit of measure, the transportation limit measure is Kg; for Segment B which has Cost/Meter as unit of measure, the transportation limit measure is Meter.

Thirdly, with reference to FIG. 14, the user can provide data about the logistic flow on the “Segment transportation data” page. As can be seen each segment identified by segment name has a sourcing country, a receiving facility ID and a quantity. Users can provide data about the logistic flow for each segment. The logistic flow consists of a certain number of quantity to transfer from the different sourcing countries to different receiving facilities. The measure of quantity is what has been defined as transportation limit. For example, for the Segment A which has Kg as transportation limit measure, the typical logistic flow can be 10000 Kg to transport from France to the Facilities 25.

Fourthly, with reference to FIG. 15, the user can provide the vendor payment time in number of days for the calculation of inventory cost on the “vendor payment time” page. Users can provide for each economic country the vendor payment time (VPT) in number of days.

Fifthly, and with reference to FIG. 16, the user can provide the on hand time (OHT) by economic country and by receiving facility on the “OHT” page by select the economic country and providing the on hand time period (in number of days) for each receiving facility. On Hand Time is the estimated average time inventory is on hand between Receipt and Sale.

Sixthly, and with reference to FIG. 17, the user can provide the WACC (weighted average cost of capital) on the “WACC” page by providing the WACC of the company (in %). Users only need to provide one WACC.

FIG. 18, illustrates the interface presented to the user by the computer system in response to the user selecting button 40 of interface 14 of FIG. 7; that is, the interface presented for “step 3”. The as-is cost data is input by the user using this interfaces and the computer system stores the input data in database 12 in a table corresponding to that shown in the Figure.

In FIG. 18, the user can (i) select the category, (ii) select the segment name, (iii) provide cost value by cost component for the selected segment, and (iv) click on the “Record” button to record or refresh the cost component values after modification.

As can be seen from FIG. 18, a cost component type identifier (ID) is defined for each of the costs (raw material cost, machine depreciation, tooling cost, energy cost, labor cost, other overheads, and supplier margin). Each cost component type ID has a corresponding cost component identifier (ID) which can be the same as the cost component type ID (e.g. for Machine depreciation cost, tooling cost, energy cost, labor cost, other overheads, supplier margin) or at a more detailed resolution such as “Alloy Steel” for Raw materials cost.

The cost value is in the currency defined as segment currency in step 1. The unit of measure for the cost breakdown is also the one defined in step 1.

FIG. 19 illustrates the interface presented to the user by the computer system in response to the user selecting button 42 of interface 14 of FIG. 7; that is, the interface presented for “step 4”. The supplier margin data is input by the user using this interface and the computer system stores the input data in database 12 in a table corresponding to that shown in the Figure.

In FIG. 19, the user can (i) select the segment name, and (ii) provide the supplier margin in % of ex-works cost. The LCC supplier margin is the average margin for LCC suppliers who operate within a certain segment.

After the user has entered the data by using buttons 36 to 40, (and optionally updated the factor costs using buttons 46 to 58), the computer system is operable to present the interface 14 shown in FIG. 7 and repeated in FIG. 20.

In response to the user selection of the “Update queries” button 62 at the bottom of the Home page, the computer system updates the database and presents the message and interface of FIG. 21 which offers the option of “do you want to launch the calculation now?”. In response to the user selection of “yes” button, the computer system launches the calculation. In response to the user selection of “no” button, the computer system presents interface 14, the home page of FIG. 14.

After launching the calculation, the user can use the button 42 to view the output data.

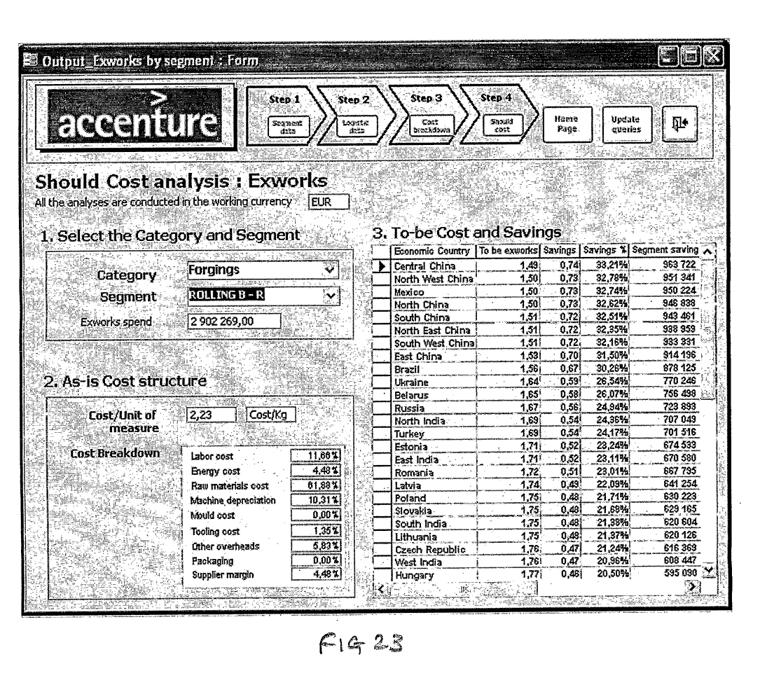

FIG. 23 shows the ex-works cost output. The as-is cost structure is also displayed and comprises the following cost components:

COST/UNIT OF MEASURE=Raw materials cost+Energy cost+Labor cost+Machine depreciation+Tooling cost+Mould cost+Other overheads+Packaging cost+Supplier margin (all cost components that were initially entered by the user (c.f. FIG. 18));

LABOR COST=labor cost initially entered by the user for this segment/Cost per unit of measure for the segment;

ENERGY COST=energy cost initially entered by the user for the segment/Cost per unit of measure for the segment;

RAW MATERIALS COST=raw materials costs initially entered by the user for the segment/Cost per unit of measure for the segment;

MACHINE DEPRECIATION=machine depreciation cost initially entered by the user for the segment/Cost per unit of measure for the segment;

MOULD COST=mould cost initially entered by the user for the segment/Cost per unit of measure for the segment;

TOOLING COST=tooling cost initially entered by the user for the segment/Cost per unit of measure for the segment;

OTHER OVERHEADS=other overheads initially entered by the user for the segment/Cost per unit of measure for the segment;

PACKAGING=packaging cost initially entered by the user for the segment; and

SUPPLIER MARGIN=supplier margin cost initially entered by the user for the segment.

The computer system is operable to calculate the potential cost by multiplying one or more cost components of the as-is cost structure by one or more cost conversion factors. For each LCC, the costs are calculated using the following as-is cost components and cost conversion factors:

LABOR COST=the labor cost in the as-is cost structure*the labor cost ratio of the LCC/the initial supplier country;

ENERGY COST=the energy cost in the as-is cost structure*the energy cost ratio of the LCC/the initial supplier country;

RAW MATERIALS COST=the raw materials cost in the as-is cost structure*the raw materials cost ratio of the LCC/the initial supplier country;

MACHINE DEPRECIATION=unchanged as in the as-is cost structure;

MOULD COST=unchanged as in the as-is cost structure;

TOOLING COST=unchanged as in the as-is cost structure;

OTHER OVERHEADS=the overheads ratio (overhead cost/as is total cost per unit of measure) should be unchanged.

For each LCC, the to-be ex-works cost is calculated by the sum of cost components for the LCC (which is based on the relative ratio of LCC cost and initial supplier country cost), the savings cost is calculated by the difference between the target ex-works by LCC country and the initial ex-work costs, the savings % is calculated by the difference/the initial ex-works cost, and the segment saving is calculated by the initial ex-works spend*savings %.

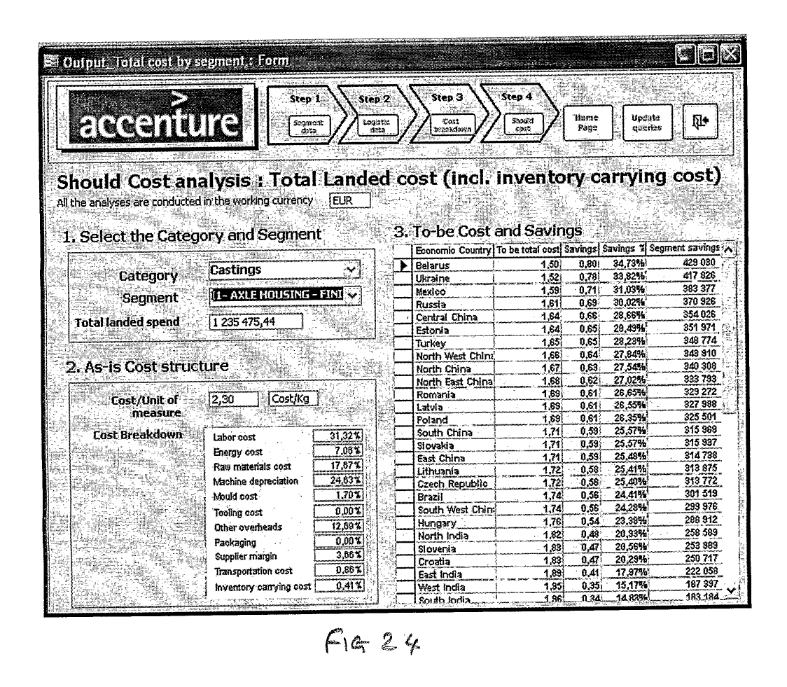

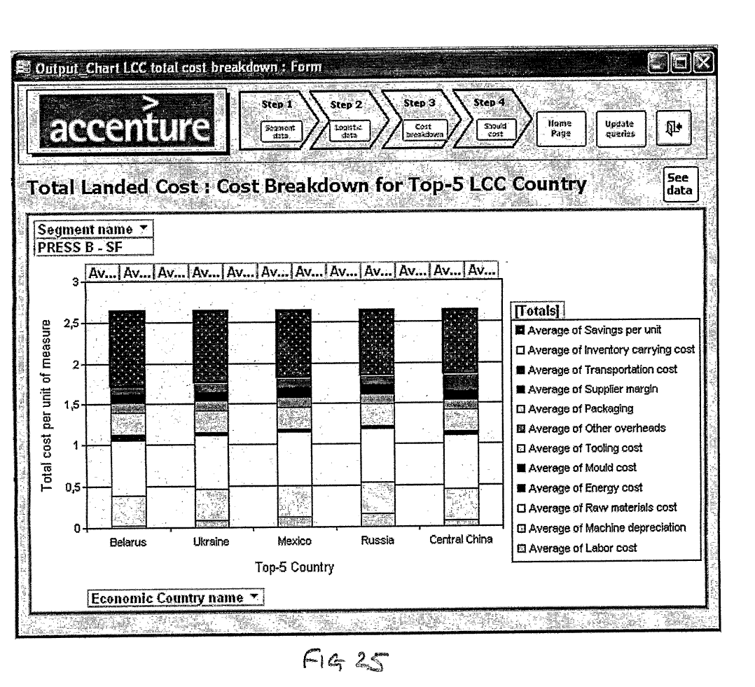

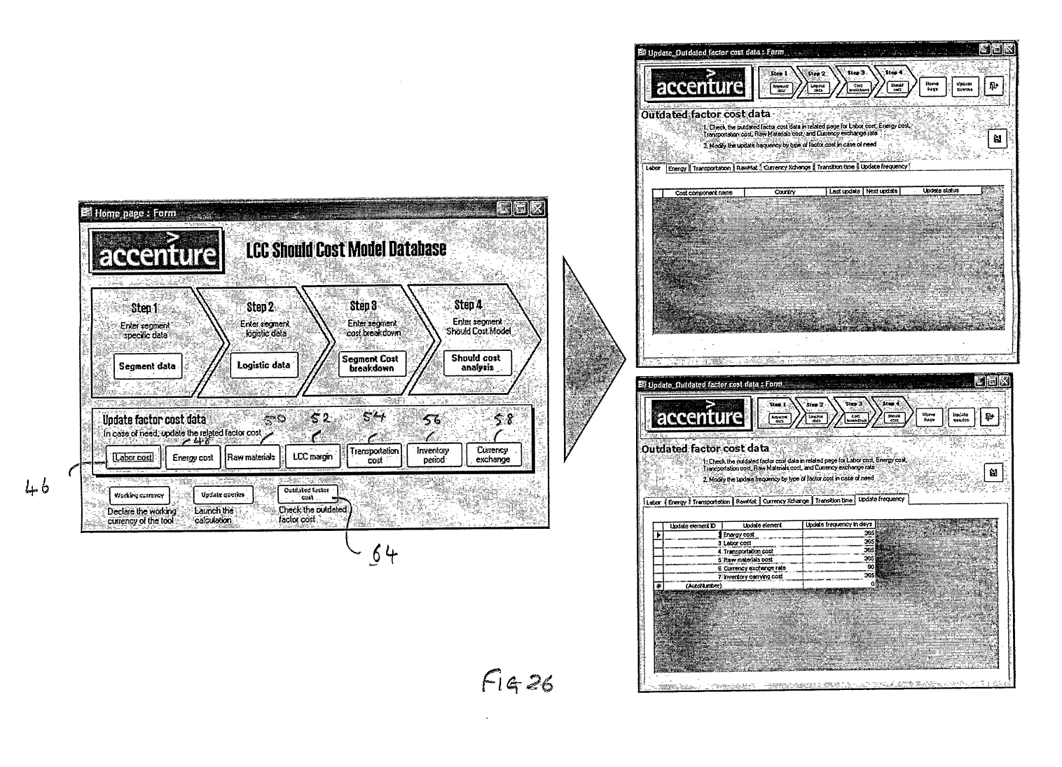

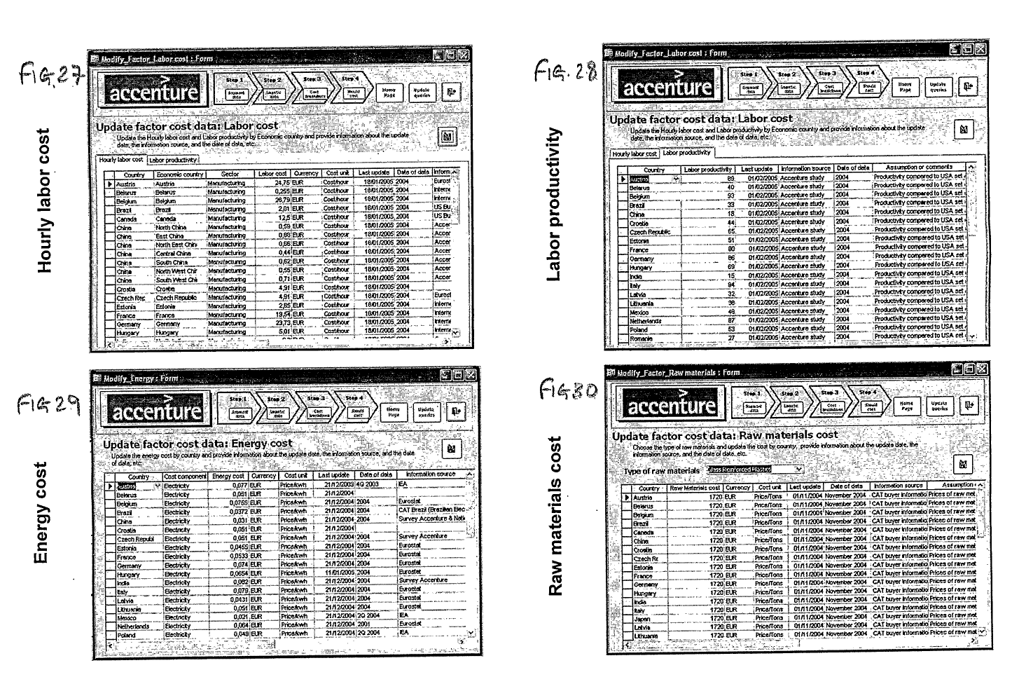

FIG. 24 shows the total landed cost output. The as-is cost structure is also displayed. Values are determined in the same way as for FIG. 23, except:

COST/UNIT OF MEASURE=ex-works cost+transportation cost/unit of measure+Inventory carrying cost/unit of measure in the initial situation (HCC supplier);

TRANSPORTATION COST=Cost per FLC or FLT (in the initial situation)/transportation limit in units of measure; and

INVENTORY CARRYING COST=COGS (equivalent of ex-works costs)*(WACC/365)*(OHT+ODT−VPT).

For each LCC the costs are calculated in the same way as FIG. 23, except:

TRANSPORTATION COST=Cost per FLC or FLT from the LCC to the facilities/transportation limit in units of measure; and

INVENTORY CARRYING COST=COGS (equivalent of ex-works costs)*(WACC/365)*(OHT+ODT−VPT) (based on the different variables' value of each specific LCC)

For each LCC, the to-be landed cost is calculated by the sum of Raw materials cost+Energy cost+Labor cost+Machine depreciation+Tooling cost+Mould cost+Other overheads+Packaging cost+Supplier margin+Transportation cost+Inventory carrying cost of each specific LCC savings cost is calculated by the difference of LCC to-be total landed cost and as-is total landed cost, the savings % is calculated by the savings/as-is total landed cost, and the segment saving is calculated by the total landed spend*savings %.

FIG. 25 shows the total landed cost for the top-5 LCC countries. The calculation is based on the to-be cost and savings tables (in FIG. 24), and only the top 5 are shown for the segment.

FIG. 26 shows how the outdated factor costs can be updated using user selectable button 64.

FIGS. 27 to 34 show how the various factor costs can be updated by using user selectable buttons 46 to 58. FIGS. 27 and 28 show how hourly labor cost and labor cost values can be updated using button 46. FIGS. 29 to 34 show how Energy cost, raw materials cost, ICC supplier margin, transportation cost, inventory period data and currency exchange data can be updated by using user selected buttons 48 to 58 respectively.

Embodiments of the present invention may be implemented using any suitable computer system, computer programming language and database. In one particular embodiment. In one embodiment the database, computer instructions and interfaces can be implemented using Microsoft Access, specifically in one embodiment Microsoft Access 2003.

The present invention has been described with reference to particular embodiments, by way of example only. It will be apparent to those skilled in the art that a person understanding this invention may conceive of changes or other embodiments or variations, which utilize the principles of this invention without departing from the broader spirit and scope of the invention as defined in the accompanying claims. All are considered within the sphere, spirit, and scope of the invention.

### Annex—Cost Sources:

### (1) Labor Cost:

### International Labor Organization:

http://laborsta.ilo.org/

### Eurostat:

http://europa.eu.int/comm/eurostat/newcronos/reference/display.do?screen=welcomeref&open=/popul/labour/earncost/lacosts/lci&language=en&product=EU_population_social_conditions&root=EU_population_social_conditions&scroll to=undefined

### US Bureau of Labor Statistic:

http://www.bls.gov/data/

### (2) Energy Cost:

### International Energy Agency:

http://www.iea.org/

### Eurostat:

http://europa.eu.int/comm/eurostat/newcronos/reference/display.do?screen=detailref&language=en&product=EU_strind&root=EU_strind/strind/ecoref/er02b1

### (3) Currency Exchange Rate:

http://www.oanda.com/convert/classic
http://www.exchangerate.com/200plus_calculator.html

1. A computer system for determining a geographic region from which to source a resource, wherein the computer system has an associated database which stores region-specific cost data for each of a plurality of geographic regions and wherein the computer system is operable to:
present an interface to enable a user to input resource data for the resource;
store the resource data;
calculate a potential cost of sourcing the resource from each of the plurality of geographic regions based on the region-specific cost data and the resource data; and
output the calculated potential cost of sourcing the resource from one or more of the plurality of geographic regions.

2. The computer system of claim 1, wherein the region-specific cost data comprises one or more of labor cost data, energy cost data, raw material cost data, supplier margin data, transportation cost data, inventory period data and currency exchange data.

3. The computer system of claim 1, wherein the resource data comprises (a) resource-specific data and (b) resource logistic data.

4. The computer system of claim 3, wherein the resource-specific data comprises one or more of resource spend and unit of measure.

5. The computer system of claim 3, wherein the resource logistic data comprises one or more of source geographic region data, receiving facility data, transportation limit data, resource transportation data, vendor payment time data, on hand time data and weighted average cost of capital data.

6. The computer system of claim 1, wherein the computer system is operable to:
present an interface to enable a user to input as-is cost data; and
store the as-is cost data.

7. The computer system of claim 6, wherein the region-specific cost data comprises one or more cost conversion factors and the computer system is operable to calculate the potential cost by multiplying one or more components of the as-is cost structure by one or more of the cost conversion factors.

8. The computer system of claim 1, wherein the computer system is operable to:
present an interface to enable a user to input supplier margin data for the resource; and
store the supplier margin data.

9. The computer system of claim 1, wherein the computer system is operable to:
present an interface to enable a user to update the region-specific cost data; and
store the updated region-specific cost data.

10. The computer system of claim 1, wherein the computer system is operable to calculate the potential cost as one or more of an ex-works cost and a total landed cost.

11. The computer system of claim 10, wherein the ex-works cost comprises one or more of a labor cost component, an energy cost component, a raw material cost component, a machine depreciation cost component, a mould cost component, a tooling cost component, an other overheads cost component, a packaging cost component and a supplier margin cost component.

12. The computer system of claim 10, wherein the total landed cost comprises one or more of a labor cost component, an energy cost component, a raw material cost component, a machine depreciation cost component, a mould cost component, a tooling cost component, an other overheads cost component, a packaging cost component, a supplier margin cost component, a transportation cost component and an inventory carrying cost component.

13. The computer system of claim 6, wherein the computer system is operable to calculate and output a cost saving compared with the as-is cost.

14. The computer system of claim 10, wherein the computer system is operable to output one or more of the ex-works cost, the total landed cost and the total landed cost for a group of regions where the potential cost is lowest.

15. The computer system of claim 14, wherein the computer system is operable to output the potential cost showing each cost component.

16. The computer system of claim 1, wherein the computer system is operable to:
present an interface to enable a user to input resource data for multiple resources as resource segments, each resource segment corresponding to a respective resource;
store the resource data for each of the resource segments;
calculate a potential cost for each resource segment of sourcing the respective resource from each of the plurality of geographic regions based on the region-specific cost data and the resource data for the resource segment; and
output by resource segment the calculated potential cost of sourcing the respective resource from one or more of the plurality of geographic regions.

17. The computer system of claim 1, wherein the geographic regions comprise one or more countries.

18. A method carried out by a computer system comprising a display and having an associated database which stores region-specific cost data for each of a plurality of geographic regions, the method being for determining a geographic region from which to source a resource and comprising:
presenting, via the display, an interface to enable a user to input resource data for a resource;
storing the resource data;
calculating a potential cost of sourcing the resource from each of the plurality of geographic regions based on the region-specific cost data and the resource data; and
outputting, via the display, the calculated potential cost of sourcing the resource from one or more of the plurality of geographic regions.

19. The method of claim 18, wherein the region-specific cost data comprises one or more of labor cost data, energy cost data, raw material cost data, supplier margin data, transportation cost data, inventory period data and currency exchange data.

20. The method of claim 18, wherein the resource data comprises (a) resource-specific data and (b) resource logistic data.

21. The method of claim 20, wherein the resource-specific data comprises one or more of resource spend and unit of measure.

22. The method of claim 20, wherein the resource logistic data comprises one or more of source geographic region data, receiving facility data, transportation limit data, resource transportation data, vendor payment time data, on hand time data and weighted average cost of capital data.

23. The method of claim 18, further comprising:
presenting, via the display, an interface to enable a user to input as-is cost data; and
storing the as-is cost data.

24. The method of claim 23, wherein the region-specific cost data comprises one or more cost conversion factors and wherein calculating the potential cost comprises multiplying one or more components of the as-is cost structure by one or more of the cost conversion factors.

25. The method of claim 18, further comprising:
presenting, via the display, an interface to enable a user to input supplier margin data for the resource; and
storing the supplier margin data.

26. The method of claim 18, further comprising:
presenting, via the display, an interface to enable a user to update the region-specific cost data; and
storing the updated region-specific cost data.

27. The method of claim 18, comprising calculating the potential cost as one or more of an ex-works cost and a total landed cost.

28. The method of claim 27, wherein the ex-works cost comprises one or more of a labor cost component, an energy cost component, a raw material cost component, a machine depreciation cost component, a mould cost component, a tooling cost component, an other overheads cost component, a packaging cost component and a supplier margin cost component.

29. The method of claim 27, wherein the total landed cost comprises one or more of a labor cost component, an energy cost component, a raw material cost component, a machine depreciation cost component, a mould cost component, a tooling cost component, an other overheads cost component, a packaging cost component, a supplier margin cost component, a transportation cost component and an inventory carrying cost component.

30. The method of claim 23, further comprising calculating and outputting a cost saving compared with the as-is cost.

31. The method of claim 27, further comprising outputting one or more of the ex-works cost, the total landed cost and the total landed cost for a group of regions where the potential cost is lowest.

32. The method of claim 31, further comprising outputting the potential cost showing each cost component.

33. The method of claim 18, comprising:
presenting, via the display, an interface to enable a user to input resource data for multiple resources as resource segments, each resource segment corresponding to a respective resource;
storing resource data for each of the resource segments;
calculating a potential cost for each resource segment of sourcing the respective resource from each of the plurality of geographic regions based on the region-specific cost data and the resource data for the resource segment; and
outputting, via the display, by resource segment the calculated potential cost of sourcing the respective resource from one or more of the plurality of geographic regions.

34. The method of claim 18, wherein the geographic regions comprise one or more countries.

35. The method of claim 18, further comprising sourcing the resource from one of the plurality of geographic regions.

36. A method for determining a geographic region from which to source a resource, comprising:
determining region-specific cost data for each of a plurality of geographic regions;
determining resource data for a resource;
calculating a potential cost of sourcing the resource from each of the plurality of geographic regions based on the region-specific cost data and the resource data; and
using the calculated potential costs to determine from which geographic region to source the resource.

37. The method of claim 36, wherein the region-specific cost data comprises one or more of labor cost data, energy cost data, raw material cost data, supplier margin data, transportation cost data, inventory period data and currency exchange data.

38. The method of claim 36, wherein the resource data comprises resource logistic data comprising one or more of source geographic region data, receiving facility data, transportation limit data, resource transportation data, vendor payment time data, on hand time data and weighted average cost of capital data.

39. The method of claim 36, comprising calculating the potential cost as one or more of an ex-works cost and a total landed cost.

40. The method of claim 36, wherein the region-specific cost data comprises one or more cost conversion factors and wherein calculating the potential cost comprises multiplying one or more components of the as-is cost structure by one or more of the cost conversion factors.

41. The method of claim 36, further comprising sourcing the resource from one of the plurality of geographic regions.

42. A computer readable medium having stored thereon computer-executable instructions comprising:
instruction code for presenting an interface to enable a user to input resource data for a resource;
instruction code for storing the resource data;
instruction code for calculating a potential cost of sourcing the resource from each of a plurality of geographic regions based on a region-specific cost data and the resource data; and
instruction code for outputting the calculated potential cost of sourcing the resource from one or more of the plurality of geographic regions.
